(19) United States
(12) Patent Application Publication
(10) Pub. No.: US 2016/0012746 A1
(43) Pub. Date: Jan. 14, 2016

(54) System And Method For Enhancing And Tracking Semantics Capabilities And Skills

(71) Applicant: Gideon HARAN, (US)

(72) Inventor: Gideon HARAN, Tel Aviv (IL)

(21) Appl. No.: 14/772,457

(22) PCT Filed: Mar. 4, 2014
(86) PCT No.: PCT/IL14/50216

§ 371 Date: Sep. 3, 2015

Related U.S. Application Data
(60) Provisional application No. 61/773,305, filed on Mar. 6, 2013.

(51) Int. Cl. G09B 17/00; G09B 19/06; G06F 17/27

(52) U.S. Cl. CPC G09B 17/003; G06F 17/2785; G06F 17/2795; G09B 19/06

(57) ABSTRACT

A system for enhancing semantic capabilities, the system comprising a processor configured to: (a) receive a start word and a target word; (b) display a first list of words that are semantically related to the start word; (c) receive data indicative of a selected word, selected by a user from the first list of words; (d) display a second list of words that are semantically related to the selected word, if the selected word is not the target word; (e) receive data indicative of an additional selected word, selected by the user from the second list of words; and (f) repeat steps (d) to (e) using the additional selected word as the selected word, until a first criterion is met.

### FIELD OF THE PRESENTLY DISCLOSED SUBJECT MATTER

The presently disclosed subject matter relates to the field of semantics, and more specifically to the field of enhancing and tracking semantic capabilities and skills.

### BACKGROUND

Nowadays, when learning a new language or when dealing with weakening of the human memory and its linguistic skills, various methods are used. However, such methods are usually limited by their ability to create motivation and incentives for the users. In addition, such methods usually do not represent a real life environment and challenges. Furthermore, nowadays, analyzing linguistic skills and language trends is usually limited by the ability to gather sufficient heterogenic data that includes data gathered from people of different cultures, ages, mother tongues, etc. There is thus a need in the art for a new method and system for enhancing and tracking semantic capabilities and skills.

### SUMMARY

According to one aspect, there is provided a method for enhancing semantic capabilities, the method comprising:
(a) receiving a start word and an end word associated with a given challenge;
(b) displaying the start word;
(c) querying a thesaurus for semantically related words having a semantic relation with the start word;
(d) displaying the semantically related words;
(e) receiving data indicative of a selected word from the semantically related words, selected by a user;
(f) if the selected word is not the end word, querying the thesaurus for additional semantically related words having a semantic relation with the selected word;
(g) displaying the additional semantically related words;
(h) receiving data indicative of an additional selected word, selected by the user; and
(i) repeating steps (f) to (h) until the additional selected word is the end word.

According to certain aspects, the start word and the end word are connected by at least one path.

According to certain aspects, the method further comprises calculating a grade for the given challenge.

According to another aspect, there is provided a system for enhancing semantic capabilities, the system comprising a processor configured to:
(a) receive a start word and an end word associated with a given challenge;
(b) display the start word;
(c) query a thesaurus for semantically related words having a semantic relation with the start word;
(d) display the semantically related words;
(e) receive data indicative of a selected word, selected by a user;
(f) if the selected word is not the end word, query the thesaurus for additional semantically related words having a semantic relation with the selected word;
(g) display the additional semantically related words;
(h) receive data indicative of an additional selected word, selected by the user; and
(i) repeat steps (f) to (h) until the additional selected word is the end word.

According to certain aspects, the start word and the end word are connected by at least one path.

According to certain aspects, the processor is further configured to calculate a grade for the given challenge.

According to another aspect, there is provided a computerized method for enhancing semantic capabilities, the method comprising:
(a) receiving, by a processor, a start word and a target word;
(b) displaying a first list of words that are semantically related to the start word;
(c) receiving data indicative of a selected word, selected by a user from the first list of words;
(d) displaying a second list of words that are semantically related to the selected word, if the selected word is not the target word;
(e) receiving data indicative of an additional selected word, selected by the user from the second list of words; and
(f) repeating steps (d) to (e) using the additional selected word as the selected word, until a first criterion is met.

In some cases, the first criterion is met by the additional selected word being the target word.

In some cases, the start word and the end word are connected by at least one path.

In some cases, the start word and the target word are associated with a challenge.

In some cases, the method further comprises calculating a grade for the given challenge.

In some cases the challenge is associated with a difficulty level.

According to still another aspect, there is provided a system for enhancing semantic capabilities, the system comprising a processor configured to:
(a) receive a start word and a target word;
(b) display a first list of words that are semantically related to the start word;
(c) receive data indicative of a selected word, selected by a user from the first list of words;
(d) display a second list of words that are semantically related to the selected word, if the selected word is not the target word;
(e) receive data indicative of an additional selected word, selected by the user from the second list of words; and
(f) repeat steps (d) to (e) using the additional selected word as the selected word, until a first criterion is met.

In some cases, the first criterion is met by the additional selected word being the target word.

In some cases, the start word and the end word are connected by at least one path.

In some cases, the start word and the target word are associated with a challenge.

In some cases, the processor is further configured to calculate a grade for the given challenge.

In some cases, the challenge is associated with a difficulty level.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of a system for enhancing and tracking semantic capabilities and skills, in accordance with the presently disclosed subject matter;

FIG. 2A is a schematic illustration of an exemplary general thesaurus, in accordance with the presently disclosed subject matter;

FIG. 2B is a schematic illustration of an exemplary thesaurus containing exemplary values, in accordance with the presently disclosed subject matter;

FIG. 3 is a flowchart illustrating one example of a sequence of operations carried out for performing a challenge in the system, in accordance with the presently disclosed subject matter;

FIG. 4 is a flowchart illustrating one example of a sequence of operations carried out for inserting a new challenge to the system, in accordance with the presently disclosed subject matter;

FIG. 5 is a flowchart illustrating one example of a sequence of operations carried out for searching for paths between a given start word and a given target word, in accordance with the presently disclosed subject matter;

FIG. 6 is a flowchart illustrating one example of a sequence of operations carried out for calculating a score for a challenge, in accordance with the presently disclosed subject matter;

FIG. 7 is a flowchart illustrating one example of a sequence of operations carried out for calculating a difficulty level of a challenge, in accordance with the presently disclosed subject matter; and

FIG. 8 is a flowchart illustrating one example of a sequence of operations carried out for analyzing data from challenges, in accordance with the presently disclosed subject matter.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “receiving”, “displaying”, “querying”, “repeating”, “calculating”, “analyzing” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

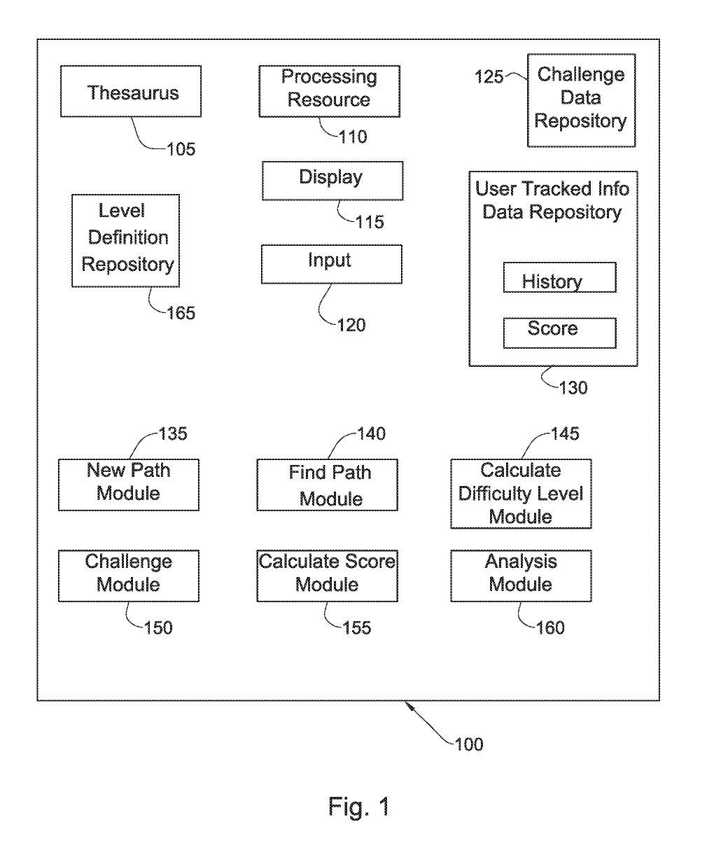

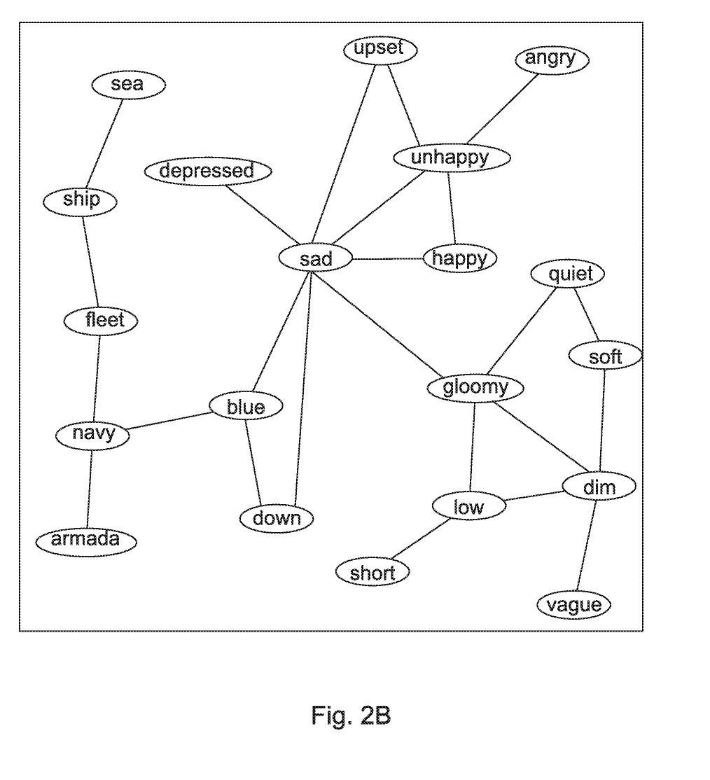

In embodiments of the presently disclosed subject matter, fewer, more and/or different stages than those shown in FIGS. 3-8 may be executed. In embodiments of the presently disclosed subject matter one or more stages illustrated in FIGS. 3-8 may be executed in a different order and/or one or more groups of stages may be executed simultaneously. FIG. 1 illustrates a general schematic of the system architecture in accordance with an embodiment of the presently disclosed subject matter. Each module in FIG. 1 can be made up of any combination of software, hardware and/or firmware that performs the functions as defined and explained herein. The modules in FIG. 1 may be centralized in one location or dispersed over more than one location. In other embodiments of the presently disclosed subject matter, the system may comprise fewer, more, and/or different modules than those shown in FIG. 1.

Bearing this in mind, attention is drawn to FIG. 1, showing a block diagram schematically illustrating one example of a system for enhancing and tracking semantic capabilities and skills, in accordance with the presently disclosed subject matter.

According to some examples of the presently disclosed subject matter, system 100 can comprise one or more processing resources 110. The one or more processing resources 100 can be processing units, microprocessors, microcontrollers or any other computing devices or modules, including multiple and/or parallel and/or distributed processing units, which are adapted to independently or cooperatively process data for controlling relevant system 100 resources and for enabling operations related to system 100 resources. It can be appreciated that system 100 and/or any of its components, can be distributed between a plurality of interconnected computerized devices (e.g. connected over one or more computer networks).

System 100 can further comprise a display 115 for displaying output to a user and input means 120 (such as a keyboard, a mouse, a touch screen, etc.) for receiving input from the user.

In some cases, system 100 can comprise, or be otherwise associated with, one or more of the following data repositories: Thesaurus 105, Level Definition Repository 165, Challenge Data repository 125 and User Tracked info Data Repository 130.

The data repositories can be, for example, databases, storage systems, memory including Read Only Memory—ROM, Random Access —Memory RAM, or any other type of memory, etc. In some cases, two or more of the data repositories, and in more particular cases, all of the data repositories, can be stored on a common location, e.g. on a common database, a common storage system, a common memory device, etc., and in such cases the distinction between the data repositories can optionally be logical.

In some cases, each of the data repositories can be configured to enable retrieval, update and deletion of the stored data. In some cases, the data repositories can be distributed between two or more geographical locations. In some cases, the data repositories can be additionally or alternatively distributed between a plurality of interconnected computerized devices (e.g. connected over one or more computer networks).

In some cases, Thesaurus 105 can comprise a plurality of words and additional metadata associated therewith. Some examples of metadata that can be associated with a word are a language classification of the word (while noting that a thesaurus, like a dictionary, is language specific), information of various relationships of the word with other words (such as synonyms, antonyms, different spelling options of the same word, or words having any type of semantic relation to the word), a classification of the word (e.g. a noun, a verb, an adjective, etc.), a grade indicative of the commonality of the word (for example, a word that is used more often will be graded higher than a word that is less often used), etc.

In some cases, in addition to the information of the various relationships of the word with other words, information of the strength of the relationship can also be stored (various known methods and techniques can be used for calculating the strengths of the relationships). The information of the strength of the relationships can be used, for example, for sorting the words according to their relevance when providing a user with lists of words, as further detailed with respect to FIG. 3.

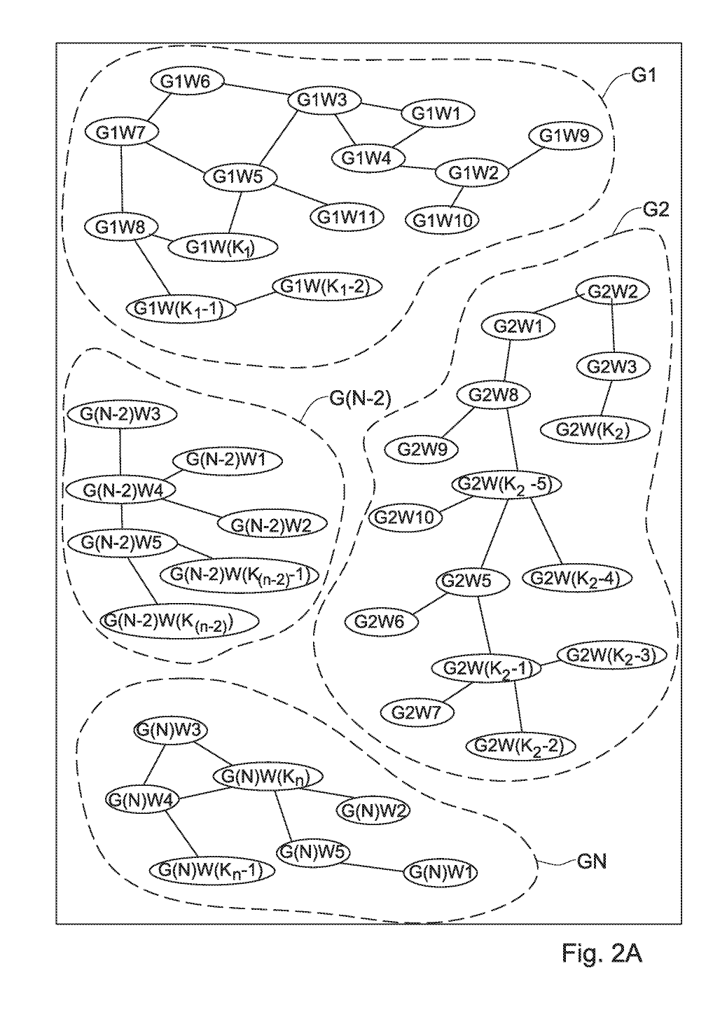

It is to be noted that an exemplary thesaurus is presented in FIGS. 2A and 2B herein, also showing relationships between various words comprised therein for exemplary purposes. It is to be further noted that the Thesaurus 105 can be updated and new words and/or semantic relationships can be introduced thereto. In some cases, words that are not yet recognized by an official institute can be introduced as well, thereby reflecting language evolution as it occurs.

In some cases, the Challenge Data Repository 125 can comprise the available Challenges for the system users to resolve.

A challenge is an interaction with a user of the system 100, in which the user is provided with a “start word” and a “target word”, both defined by the challenge, and is required to find a path, comprised of semantically related words, that leads to the “target word”. In order to find the path, the user is provided, along with the start word, with a list of words that have semantic relation with the start word, and the user is required to select a word from the list. Upon selection of the word, the user is provided with a new list of words that have semantic relation with the selected word, and the user is required to select another word from the new list. This process, of the user selecting a word and provided with a new list of semantically related word is repeated iteratively until the target word appears in the provided list and gets selected by the user. The path is the list of words that the user selected, starting from the start word (which can be considered as part of the path, or not) and until the target word was selected (which can be considered as part of the path, or not). It is to be noted that in some cases more than one feasible path that connects the start word and the target word exists, as further detailed herein.

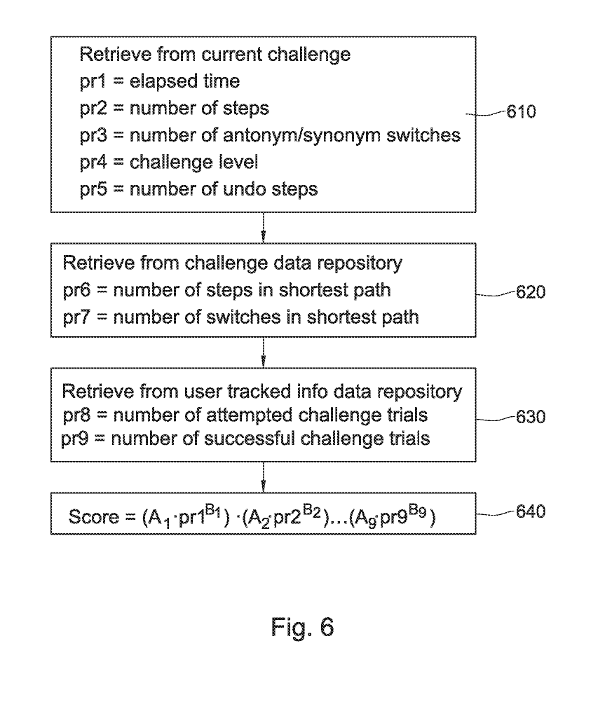

The Challenge Data Repository 125 can contain various parameters for each Challenge. Such parameters can include the “start word” and the “target word”, and, optionally, one or more of: at least one feasible challenge resolution path (that leads from the start word to the target word), the shortest possible challenge resolution path (i.e. the shortest path from the start word to the target word), an indication of the challenge execution level (that can be calculated by the Calculate Difficulty Level Module 145, as detailed herein, inter alia with respect to FIG. 7), one or more hints for assisting the user in resolution of the challenge, etc. A hint can be, for example, reducing the number of options available for selection by the user, performing the current step automatically by automatically selecting a certain word (e.g. the word defined by the shortest path or by a feasible challenge resolution path), etc.

It is to be noted that in some cases, Challenge Data Repository 125 can comprise only feasible challenges. A feasible challenge is a challenge in which at least one path connects the start word and the target word. In some cases, some of the challenges stored on the Challenge Data Repository 125 can be impossible to resolve (as no path connects the start word and the target word). In still further cases, there is not enough information for determining whether a certain challenge that is introduced into the system is feasible or not.

In some cases, as indicated herein, each challenge can be associated with a challenge execution level indicative of the complexity of the challenge. For this purpose, the Level Definition Repository 165 can comprise a list of system challenge execution levels, indicative of complexity of the challenges. A challenge of a lower challenge execution level would be an easier challenge than one of a higher challenge execution level. The challenge execution level can define various parameters for the challenges associated therewith. Such parameters can include any one or more of the following: the available time given to the user for completing the challenge, the assistance the system will be allowed to provide to the user (e.g. by way of hints), the maximal number of word selections (i.e. the maximal number of words in the path from the start word to the target word, where the maximal number is larger than, or equal to, the number of words that comprise the shortest path), number of feasible paths connecting the start word and the target word, number of options to be provided to the user at each stage, a minimal commonality of the words comprised in the feasible paths, etc.

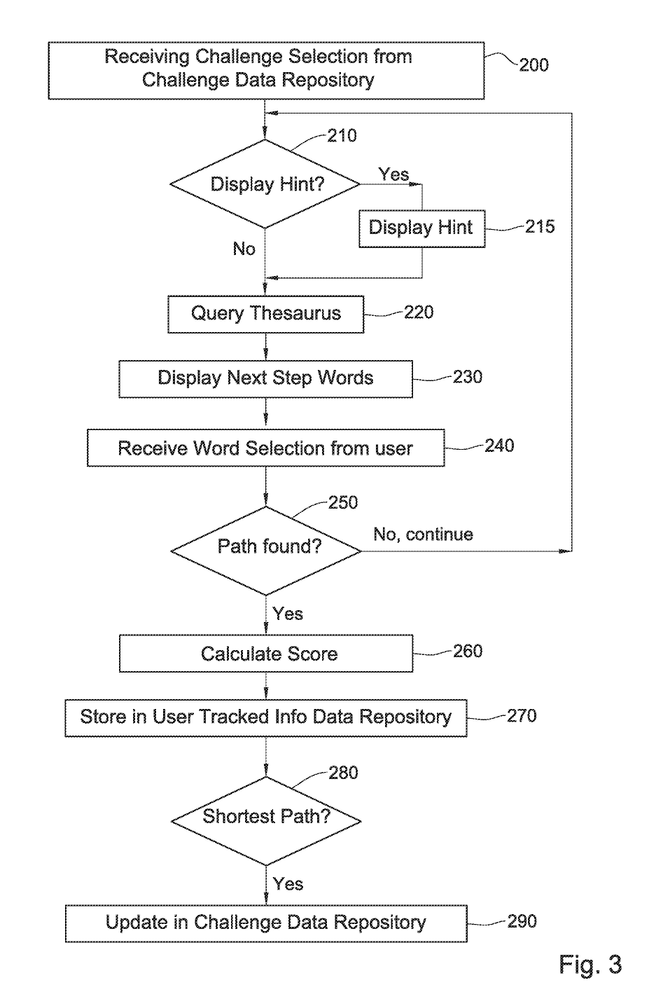

In accordance with some examples of the presently disclosed subject matter, new challenges can be introduced into the system 100. One way of adding new challenges to the Challenge Data Repository 125 is by utilizing the New Path Module 135 as detailed herein, inter alia with respect to FIG. 4.

It is to be noted, as further detailed herein, that the challenge execution level of various challenges can be updated dynamically, e.g. based on the challenge execution history (e.g. success rate of solving the challenge, number of required moves, etc.).

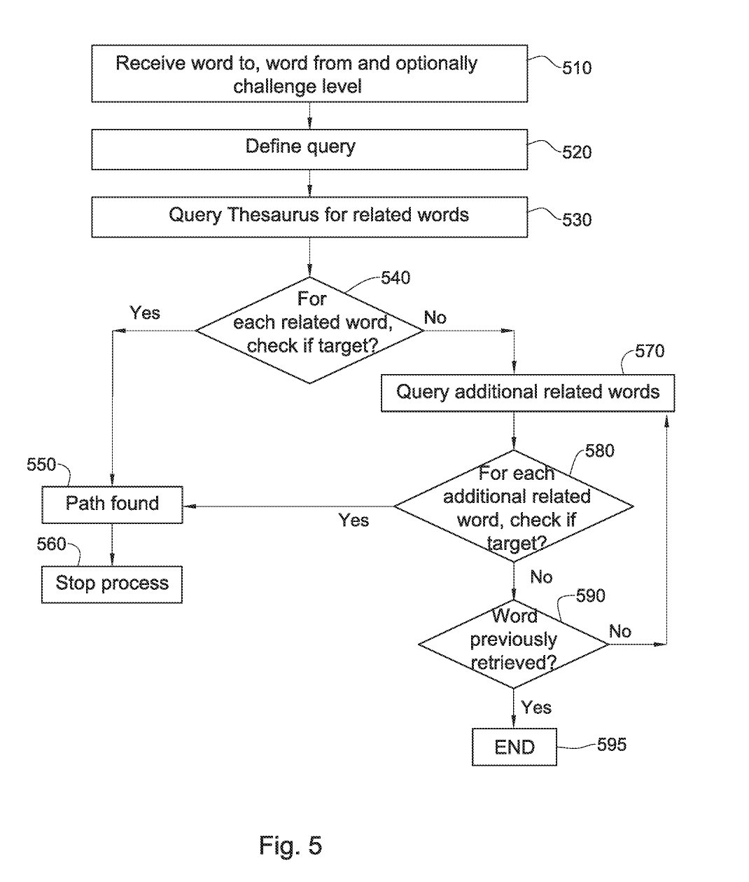

In some cases, User Tracked info Data Repository 130 can store various information of actions performed by the users of the system 100 while using the system 100 (e.g. when executing a challenge). The User Tracked info Data Repository 130 may be perceived as a log book or a “black box” recorder in a way that it stores all, or part, of the user and/or system actions performed while the system 100 is in operation mode. In some cases, it can store information of all actions performed by users during performance of a challenge. In some cases, additionally or alternatively, the User Tracked info Repository 130 can also store the elapsed time between each action performed by the user (e.g. between each word selection) while attempting to resolve a challenge. In some cases, additionally or alternatively, The User Tracked info Repository 130 can store the challenge scores per user per challenge, for example as calculated by the Calculate Score Module 155 (as detailed herein, inter alia with respect to FIG. 6). In some cases, additionally or alternatively, the User Tracked info Data Repository 130 can also store a general score per challenge, and/or a general score per user. It is to be noted that these are mere examples of information that can be stored on the User Tracked info Data Repository 130.

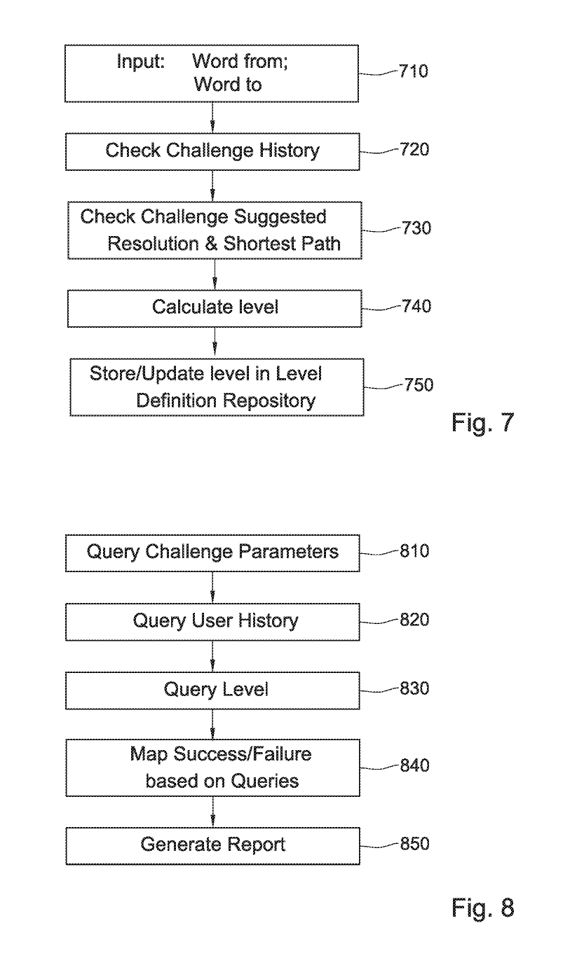

The information stored on the User Tracked info Data Repository 130 can inter alia enable study and analysis, as well as reporting, of the challenge execution and its results (e.g. using the Analysis Module 160 as detailed herein, inter alia with respect to FIG. 8). Any other information, including information that can be used for analyzing and studying the performance of one or more users of the system 100, can also be stored on the User Tracked info Data Repository 130.

In some cases, the system 100 can further comprise the following modules:
New Path Module 135
Find Path Module 140
Calculate Difficulty Level Module 145
Challenge Module 150
Calculate Score Module 155
Analysis module 160

In some cases, the New Path Module 135 can be configured to introduce a new challenge (i.e. path) to the system 100, as further detailed herein, inter alia with respect to FIG. 4.

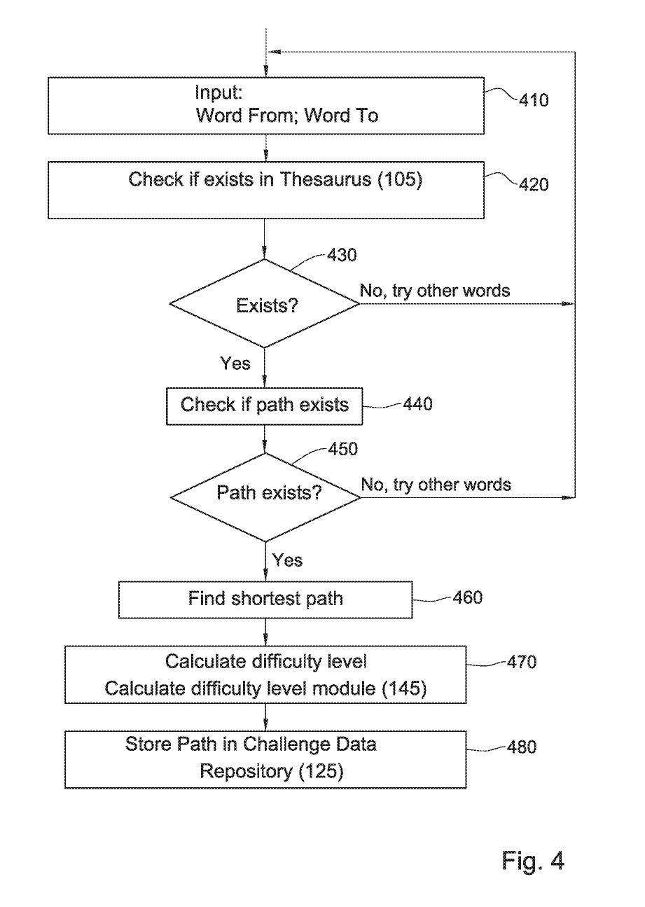

In some cases, the Find Path Module 140 can be configured to check existence of a Path between a given start word and a given target word. If a Path does not exist, the challenge associated with the given start word and the given end word has no resolution (see FIG. 2A and FIG. 2B for elaboration). Furthermore, the Find Path module 140 can be configured to find the “Shortest Path” which can be considered in some cases as a preferable challenge resolution, as further detailed herein, inter alia with respect to FIG. 5.

In some cases, the Calculate Difficulty Level Module 145 can be configured to calculate the difficulty level with which each challenge is associated. The calculation can take into account various parameters such as for example the success ratio of past attempts to solve the challenge, the length of the shortest path between the start word and the end word, the available time given to the user for completing the challenge, the assistance the system will be allowed to provide to the user (e.g. by way of hints), the maximal number of word selections the user is allowed to perform, number of feasible paths connecting the start word and the target word, number of options to be provided to the user at each stage, a minimal commonality of the words comprised in the feasible paths, etc. as further detailed herein, inter alia with respect to FIG. 7.

In some cases, the Challenge Module 150 can be configured to display a challenge to the user of the system 100 and enable the user to interact with the system (for example by way of the Input device 120 and the display device 115) and attempt to resolve the challenge, as further detailed herein, inter alia with respect to FIG. 3.

In some cases, the Calculate Score Module 155 can be configured to calculate a score for the challenge solution attempt performed by the user, whether successful or not, as further detailed herein, inter alia with respect to FIG. 3.

In some cases, the Analysis Module 160 can be configured to analyze for example by way of statistical methods (or any other methods) the skills (for example linguistic skills, cognitive skills etc.) of one or more users, based on data accessible to the system 100 (e.g. data stored in the User Tracked info data Repository 130), as further detailed herein, inter alia with respect to FIG. 8.

Attention is now drawn to FIG. 2A, showing a schematic illustration of an exemplary general thesaurus, in accordance with the presently disclosed subject matter.

A thesaurus comprises a collection of words. In FIG. 2A, words are schematically denoted as circles. Each circle represents a unique word. Each word appears only once in the drawing and in order to identify each word, a label was attached to it. As seen in FIG. 2A the labels G1W1, G2W4, GNW(Kn−1), G(N−1)W(kn−1−2) all uniquely represent words.

Words (represented by circles) that are semantically linked to other words, are drawn with a connecting line between them. Words that are semantically linked to a given word are words with similar meanings to the meaning of the word (such as synonyms), words that have an opposite meaning to the meaning of the given word (such as antonyms), or words with any other type of semantic relation to the given word.

For example, as seen in FIG. 2A, the words labeled G₁W₁ and G₁W₄ are semantically linked Also the words labeled GₙW_{Kn} and G_{N}W₃ are semantically linked Words that are not semantically related are not linked, for example the word G₁W₁ is not semantically related to any of the following: G₁W₅, G₁W₇, G₂W₄, etc., although in this example G₁W₅ and G₁W₇ are related amongst themselves.

When all the possible links are drawn, it appears, as seen in FIG. 2A, that groups of words (represented by graphs) are formed (e.g. G₁, G₂, G_{(N-2)}, G_{N}). Each word in a group is somehow linked (not necessarily directly) to all other words in the group, through a certain path that is comprised of one or more other words. For example, when looking at G₁, although G₁W₂ and G₁W₇ are not linked to each other, they are linked through other words. G₁W₂ is linked to G₁W₄ which is linked to G₁W₃, which in turn is linked to G₁W₆, which in turn is linked to G₁W₇. This series of links is called a path. One possible path has been described, denoted as P₁, between G₁W₁ and G₁W₇.

Another possible path between G₁W₂ and G₁W₇ is: G₁W₁ is connected to G₁W₃, which in turn is connected to G₁W₅, which in turn is connected to G₁W_{K1}, which in turn is connected to G₁W₈, which in turn is connected to G₁W₇. This path will be denoted as P₂.

It is evident that path P₁ (that includes 5 words, namely G₁W₁, GᵢW₄, G₁W₃, G₁W₅, G₁W₇) is shorter than path P₂ (that includes 6 words, namely G₁W₁, G₁W₃, G₁W₅, G₁W_{K1}, G₁W₈, G₁W₇).

It can be appreciated that words from one group (where each group is represented by a graph) are not semantically linked/related to words from any other group and no path may be traced between words from different groups. Thus, each word is a member of one of the groups (G₁ . . . G_{N}) and each group is comprised of 1 to Kₙ members (Kₙ denotes the number of members in group n while Kₙ₋₁ denotes the number of members in group n−1, etc.). For example, group G_{N-2} is comprised of Kₙ₋₂ words, and the following words are its members: G_{N-2}W₁, G_{N-2}W₂ , . . . , G_{N-2}W [symbol] , G_{N-2}W [symbol] , G_{N-2}W [symbol] .

It is to be noted that in case a new link between a word from a certain group and another word from another group is introduced into the system, both groups are united to form a single group, and at least one path connects any two words from the newly formed united group.

It is to be noted that a challenge in the system would be to find a path between two words (a start word and a target word), and in some cases, to find the shortest path. In some cases, all challenges of the system 100 are challenges that can be solved as at least one path from the challenge's start word and its target word exists. It is to be noted, as indicated above, that in some cases some challenges may be unsolvable or the determination whether they are solvable or not has not yet been made. The existence of a path (that can only exist between words that belong to the same group, as detailed herein) can be verified by utilizing the Find Path Module 140 as detailed herein, inter alia with respect to FIG. 4.

Turning to FIG. 2B, there is shown a schematic illustration of an exemplary thesaurus containing exemplary values, in accordance with the presently disclosed subject matter. Assuming, for the sake of example, that a challenge is defined to find a path between the words Fleet and Dim, it will be apparent that several paths are possible, for example: a first path is Fleet that is linked to Navy, that is linked to Blue, that is linked to Sad, that is linked to Gloomy that is linked to Dim; a second path is Fleet that is linked to Navy, that is linked to Blue, that is linked to Down, that is linked to Sad, that is linked to Gloomy, that is linked to Low, that is linked to Dim. It is worth nothing that Fleet and Navy are synonyms and that Navy and Blue are synonyms (both are colors related to blue), but Fleet and Blue are neither synonyms nor Antonyms, however they are semantically related words. Both the first path and the second path are valid paths, but the first path is a shorter one. In some cases, a few different paths having the same lengths can exist. Also, it is worth noting that some words are “dead end” words, meaning that they can be reached only through one word and so cannot be a go through word of any path. Such words would be, for example, as seen in FIG. 2B, “short”, “angry”, “vague”, “armada”, “sea”, “depressed”, that are all connected to a single word (it is to be noted that this is a mere example for illustration purposes; clearly these words have semantic relationships with many other words that are not shown in the example, however in the illustrated example itself, these words have a semantic relation with a single word only).

Turning to FIG. 3, there is shown a flowchart illustrating one example of a sequence of operations carried out for performing a challenge in the system, in accordance with the presently disclosed subject matter.

In some cases, system 100 (e.g. utilizing The Challenge Module 150), can be configured to receive a selection of a challenge available in the challenge data repository 125 (block 200). As indicated above, a challenge can be associated with a certain start word and a certain target word. In some cases, system 100 (e.g. utilizing The Challenge Module 150), can be configured to enable the user to select the challenge from a list of available challenges (that can be retrieved, for example, from the challenge data repository 125). The list of available challenges can optionally be compiled of challenges that conform to the level and skill of the user and/or to a selected level.

In other cases, the system can receive a desired start word and a desired target word, and check if the challenge data repository 125 comprises a challenge associated with the desired start word and the desired target word. If so, the corresponding challenge is selected. If not, the system 100 can try to introduce a new challenge to the system (for example in accordance with the process described with respect to FIG. 4), having the desired start word and the desired target word. If introduction of the challenge is successful, the new challenge is selected. If not, then should the system not enable performance of non-feasible challenges, the system 100 can display a notification to the user indicating that the desired challenge is not feasible. Alternatively, if the system 100 enables performance of non-feasible challenges, the non-feasible challenge having the desired start word and the desired target word (having no path connecting them), will be selected.

In some cases, instead of having the user select a challenge, the system 100 (e.g. utilizing The Challenge Module 150) can be configured to suggest a single pre-defined challenge. This may be the case for novice users of the system, for example

In some cases, the Challenge Module 150 can be configured to suggest a hint (block 210). If the user accepts the suggestion to receive a hint, the system 100 can be configured to display a hint (block 215).

After display of the hint, or in case the user did not choose to receive a hint, system 100 (e.g. utilizing The Challenge Module 150), can be configured to query the Thesaurus 105 for retrieving a group of words that have a semantic relation to the challenge's start word (block 220). In some cases, the group of words can include all of the words that have a semantic relation to the challenge's start word. In other cases, the group of words can include only part of the words that have semantic relation to the challenge's start word, and in some cases the group of words is required to include at least one word that is on a feasible path from the challenge's start word to the challenge's target word. In still other cases, the system can return no related words, for example in case that no words having semantic relation to the challenge's start word exist in the Thesaurus 105 (e.g. “dead end” words).

In some cases, system 100 (e.g. utilizing The Challenge Module 150), can be configured to display the retrieved words (retrieved in block 220) to the user, e.g. on a display device such as display 115 (block 230), and to receive an indication of a selected word selected out of the retrieved words by the user as a “next word” (block 240).

In some cases, system 100 (e.g. utilizing The Challenge Module 150), can be configured to perform a check if the word selected by the user in block 240 is the same word as the target word of the challenge (i.e. a path was successfully found) (block 250).

In case the word selected by the user is different than the challenge's target word (i.e. the challenge is not yet resolved), the system may be configured to return to block 210, however, in step 220 the system 100 can query the Thesaurus 105 for retrieving a group of words that have a semantic relation to the “next word” that is the selected word selected on block 240, and the process repeats until the challenge's target word is selected in block 240.

In case the word selected by the user is the challenge's target word (i.e. challenge successfully solved), the system 100 (e.g. utilizing The Challenge Module 150), can be configured to calculate a score (e.g. utilizing the calculate score module 155, e.g. as further detailed with respect to FIG. 6) (Block 260).

In some cases, system 100 (e.g. utilizing The Challenge Module 150), can be further configured to store all or part of the parameters related to the challenge (for example: information indicative of the user identification, information indicative of the selected words, the elapsed time between word selections, the calculated score, number of hints used, etc.) in the User Tracked info Data Repository 130 (Block 270).

In some cases, system 100 (e.g. utilizing The Challenge Module 150), can be still further configured to perform a check if the challenge resolution as performed by the user suggests a shorter path than the one stored in the challenge Data Repository 125 as the shortest path associated with this challenge. If so, system 100 can be configured to update challenge Data Repository 125 with the new shortest path (block 290).

It is to be noted that, with reference to FIG. 3, some of the blocks can be integrated into a consolidated block or can be broken down to a few blocks and/or other blocks may be added. Furthermore, in some cases, the blocks can be performed in a different order than described herein (for example, block 270 can be performed before block 260, etc.). It is to be further noted that some of the blocks are optional (e.g. block 260, etc.). It should be also noted that whilst the flow diagram is described also with reference to the system elements that realizes them, this is by no means binding, and the blocks can be performed by elements other than those described herein.

Turning to FIG. 4, there is shown a flowchart illustrating one example of a sequence of operations carried out for inserting a new challenge to the system 100, in accordance with the presently disclosed subject matter.

In some cases, system 100 (e.g. utilizing new path module 135), can be configured to receive new challenges to the system 100. In some cases such new challenges can be introduced to the system 100 manually and in other cases they can be introduced automatically (e.g. by dedicated software). In this example, one example of adding a new challenge to the system 100 by the user is described.

In some cases, system 100 (e.g. utilizing new path module 135), can be configured to receive a start word (“Word From”) and a target word (“Word To”) from the user (Block 410). In some cases, system 100 (e.g. utilizing new path module 135), can be configured to query to the Thesaurus 105 for validating that both words (“Word From”, “Word To”) appear therein (Block 420) and check if they exist (block 430). If one or both of the words (“Word From” and/or “Word To”) do not appear in the Thesaurus 105, system 100 (e.g. utilizing new path module 135) can be configured to return to Block 410. Alternatively (not shown), system 100 can be configured to ask the user to point out at least one word that is semantically related to the word that does not appear in the Thesaurus 105, and the type of semantic relation, and the system 100 can introduce the word into the thesaurus 105, along with the semantic relation pointed out by the user. In some cases, only a certain type of user can be granted permission to add new words to the Thesaurus 105.

In case both words appear in the Thesaurus 105 the system 100 (e.g. utilizing new path module 135), can be configured to check if at least one path connects the start word and the target word (e.g. utilizing the Find Path Module 140) (block 440). The system 100 can check if a path exists (Block 450) and if not, the system 100 can notify the user that no path connects the start word and the target word and the process can optionally return to block 410. Alternatively (not shown), the system 100 can be configured to ask the user to provide information of additional words and/or semantic relations between words to add to the thesaurus 105 for creating a path that connects the start word and the target word. As indicated herein, in some cases, only a certain type of user can be granted permission to add new words to the Thesaurus 105.

In case a path was found by system 100, the system 100 may be configured to find the shortest path that connects the start word and the target word (e.g. utilizing Find Path Module 140, e.g. as further detailed with respect to FIG. 5) (Block 460).

In some cases the system 100 (e.g. utilizing new path module 135) can be further configured to calculate the difficulty level of the new challenge (that has a new path associated therewith), e.g. utilizing the calculate difficulty level module 145 (Block 470).

In some cases the system 100 (e.g. utilizing new path module 135) can be configured to store the new challenge, e.g. in the Challenge Data Repository 125 (block 480). In some cases, the system 100 can store, for the new challenge, its start word and its target word, and optionally also the calculated shortest path for resolving the challenge, the calculated difficulty level of the challenge, etc.

In some cases, the user can also provide various hints that can be used during resolution of the challenge by the user (not shown in FIG. 4).

It is to be noted that, with reference to FIG. 4, some of the blocks can be integrated into a consolidated block or can be broken down to a few blocks and/or other blocks may be added. Furthermore, in some cases, the blocks can be performed in a different order than described herein (for example, block 470 can be performed before block 460, block 480 can be performed before block 470 and/or 460, etc.). It is to be further noted that some of the blocks are optional. It should be also noted that whilst the flow diagram is described also with reference to the system elements that realizes them, this is by no means binding, and the blocks can be performed by elements other than those described herein.

Turning to FIG. 5, there is shown a flowchart illustrating one example of a sequence of operations carried out for searching for paths between a given start word and a given target word, in accordance with the presently disclosed subject matter.

As described in FIG. 2A, Thesaurus 105 may contain groups of words that are not linked to each other—for example the words in group G1 (that is a graph comprising words connected by links defining semantic relations between various words in the graph) are not linked to any word at any other group/graph G2, G3 . . . G(N−1), G(N). Therefore, when introducing a new challenge to the system 100, in some cases it is desired to validate that the start word and the target word associated with the challenge are members of a certain group/graph, and in such cases, there is a solution to the challenge that is associated with the start word and target word. If the start word and the target word that are associated with the challenge are not members of the same group/graph, such a challenge cannot be resolved.

In some cases, system 100 (e.g. utilizing The Find Path Module 140), can be configured to receive some parameters such as, amongst others, the “Start Word”, The “Target Word”, and in some cases also the challenge level (Block 510).

In some cases, system 100 (e.g. utilizing The Find Path Module 140), can be configured to define a query to the Thesaurus 105 (Block 520). In some cases, the query can take into account the challenge level. For example, the challenge level can define certain allowed types of semantic relations between words that can be used as part of the challenge. In some cases, for novice users, the query can retrieve words that have a certain type or types of semantic relations with the start word (e.g. only synonyms, only antonyms, only synonyms and antonyms, etc.), whereas for expert users the query can retrieve all words that have any type of semantic relation to the start word.

In some cases, system 100 (e.g. utilizing The Find Path Module 140), can be configured to query the Thesaurus 105 for words having semantic relation (or a certain type/s of semantic relation, e.g. according to the challenge level, as detailed above) with the start word (Block 530).

In some cases, system 100 can be configured to check, for each of the retrieved semantically related words, if it is the target word (block 540). If so, a path is found and the system can store information of the newly found path (e.g. the list of words that comprise the path) (block 550). In some cases, following identification of a path, the system 100 can stop the process (Block 560). For each retrieved word, if it is not the target word, the system 100 can be further configured to query Thesaurus 105 again for additional words having semantic relation (or a certain type/s of semantic relation, e.g. according to the challenge level, as detailed above) with the retrieved word (block 570).

In some cases, system 100 can be configured to check, for each of the additional words, if it is the target word (block 580). If so, a path is found and the system can store information of the newly found path (e.g. the list of words that comprise the path) (block 550). In some cases, following identification of a path, the system 100 can stop the process (Block 560). In addition, in some cases, the system 100 can be further configured to check, for each of the additional words, if they were previously queried on the route to it, thus forming a cyclic graph/path (block 590). If so, the process ends for the specific retrieved word that meets the criterion (block 595). If not, the process can return to block 570.

The process described above provides one example of searching for feasible paths while avoiding performing endless loops over cyclic graphs.

It is to be noted that, with reference to FIG. 5, some of the blocks can be integrated into a consolidated block or can be broken down to a few blocks and/or other blocks may be added. Furthermore, in some cases, the blocks can be performed in a different order than described herein (for example, block 560 can be performed before block 550, etc.). It is to be further noted that some of the blocks are optional. It should be also noted that whilst the flow diagram is described also with reference to the system elements that realize them, this is by no means binding, and the blocks can be performed by elements other than those described herein.

Turning to FIG. 6, there is shown a flowchart illustrating one example of a sequence of operations carried out for calculating a score for a challenge, in accordance with the presently disclosed subject matter.

In some cases, system 100 (e.g. utilizing The Calculate Score Module 145), can be configured to calculate a score for a user following an attempt to solve a challenge (in some cases a score can be calculated, whether the attempt was successful or not). One way of calculating the score could be by generating a mathematical function whose parameters could be, for example (non limiting), one or more of the following: the challenge's resolution time, the elapsed time between each word selection, the number of hints used and the types of hints used, the semantic skills of the user, the challenge's difficulty level, etc. Other methods for calculating the score could use additional and/or other parameters and optionally assign each parameter with a different weight in the overall score.

In some cases, for the purpose of calculating a score, the system 100 (e.g. utilizing The Calculate Score Module 155), can be configured to retrieve (e.g. from user tracked info data repository 130) or calculate, the following exemplary parameters (non-limiting):

Parameter 1=the elapsed time for the challenge;

Parameter 2=number of steps (number of words selected by the user during resolution of the challenge);

Parameter 3=number of specific types of semantic relations found between words (e.g. synonyms, antonyms, etc.);

Parameter 4=the number of undo steps performed by the user during resolution of the challenge.

In this example, these arguments are based on the actual challenge resolution attempt, as described in Block 610.

In some cases, system 100 (e.g. utilizing The Calculate Score Module 145), can be further configured to retrieve (e.g. from the Challenge Data Repository 125) other parameters, relating to the challenge definition for which the score is calculated (block 620). Several examples (non-limiting) of such parameters are:

Parameter 5=the challenge's difficulty level;

Parameter 6=number of steps in shortest path (the number of words that comprise the shortest path between the challenge's start word and target word);

Parameter 7=number of specific types of semantic relations between words (e.g. synonyms, antonyms, etc.) in the shortest path.

In some cases, system 100 (e.g. utilizing The Calculate Score Module 145), can be configured, for example, to retrieve (e.g. from user tracked info data repository 130) additional and/or alternative parameters that are based on the user's history of challenge resolution attempts (block 630). Such parameters can be, for example (non-limiting):

Parameter 8=the number of attempted challenge trials by actual user or other users;

Parameter 9=the number of successful challenge trials by the actual user or other users.

In some cases, system 100 (e.g. utilizing The Calculate Score Module 145), can be configured to calculate an overall score, e.g. by using a formula based on any combination of one or more of the above parameters, and/or any additional parameter. In some cases, each parameter can be assigned with a different weight during the calculation of the overall score. Some examples for such weighting can be multiplying the parameter value by a given value (e.g. A₁ . . . A₉), raising the parameter's value in a certain power (e.g. B₁ . . . B₉), etc. (Block 640). In some cases, the weighting parameters (e.g. A₁ . . . A₉, B₁ . . . B₉) can be calculated based on empirical study that is based on the data stored on challenge data repository 125 and/or used tracked info data repository 130 or on any other data repository of system 100. It is to be noted that in the illustrated example there are only 9 parameters, however any number of parameters can exist, and in such cases, a corresponding number of weighting parameters can be used. It is to be noted that, with reference to FIG. 6, some of the blocks can be integrated into a consolidated block or can be broken down to a few blocks and/or other blocks may be added. Furthermore, in some cases, the blocks can be performed in a different order than described herein (for example, block 620 can be performed before block 610, block 630 can be performed before block 620 and/or block 610, etc.). It is to be further noted that some of the blocks are optional. It should be also noted that whilst the flow diagram is described also with reference to the system elements that realizes them, this is by no means binding, and the blocks can be performed by elements other than those described herein.

Turning to FIG. 7, there is shown a flowchart illustrating one example of a sequence of operations carried out for calculating a difficulty level of a challenge, in accordance with the presently disclosed subject matter.

In some cases, system 100 (e.g. utilizing The Calculate Difficulty level Module 145), can be configured to assign a difficulty level for a challenge. In some cases, the challenge's difficulty level can be calculated utilizing historical information of past resolution attempts of the challenge by one or more users of the system 100 (and in more specific cases by all users of the system 100), and/or by utilizing other parameters, e.g. parameters relating to the challenge.

In some cases, system 100 (e.g. utilizing The Calculate Difficulty level Module 145), can be configured to receive a challenge's start word and target word (Block 710). System 100 (e.g. utilizing The Calculate Difficulty level Module 145), can optionally be further configured to retrieve various parameters from the User Tracked info data Repository 130, for example historical information of past resolution attempts of the challenge (Block 720).

In some cases, the system 100 can be still further configured to retrieve various parameters relating to the challenge from the Challenge Data repository 125. Such parameters can include a precalculated challenge resolution path, or the shortest calculated challenge resolution path, etc. (Block 730).

Based on the retrieved parameters, retrieved from the User Tracked info data Repository 130 and/or from the Challenge Data repository 125, system 100 (e.g. utilizing the Calculate Difficulty level Module 145), can be configured to calculate a difficulty level for the challenge (Block 740), and store it in association with the challenge (e.g. in the Challenge Data Repository 125) (Block 750).

It is to be noted that, with reference to FIG. 7, some of the blocks can be integrated into a consolidated block or can be broken down to a few blocks and/or other blocks may be added. Furthermore, in some cases, the blocks can be performed in a different order than described herein (for example, block 730 can be performed before block 720, etc.). It is to be further noted that some of the blocks are optional. It should be also noted that whilst the flow diagram is described also with reference to the system elements that realizes them, this is by no means binding, and the blocks can be performed by elements other than those described herein.

Turning to FIG. 8, there is shown a flowchart illustrating one example of a sequence of operations carried out for analyzing data from challenges, in accordance with the presently disclosed subject matter.

In some cases, system 100 (e.g. utilizing The Analysis Module 160), can be configured to generate various types of analysis reports relating to various aspects, including user behaviors, users knowledge, users linguistic and/or cognitive skills, etc. It is to be noted that the reports can be calculated based on one or more of: on a single user basis, on a group of users basis, on all users of the system basis, on a certain challenge basis, on a group of challenges basis, on all challenges of the system basis, etc.

In some cases, system 100 (e.g. utilizing The Analysis Module 160), can be configured to query and retrieve various challenge related parameters, e.g. from the Challenge Data repository 125 (Block 810) and/or information of various challenge resolution attempts, e.g. from the User Tracked Info Data Repository 130 (Block 820).

System 100 (e.g. utilizing The Analysis Module 160), can optionally be further configured to query the relevant challenge difficulty level from the level definition repository 165 (Block 830).

In some cases system 100 (e.g. utilizing The Analysis Module 160) can be configured to map parameters regarding the actual user performance and behavior (Block 840).

In some cases system 100 (e.g. utilizing The Analysis Module 160) can be configured to generate relevant reports, based on the mapped parameters (Block 850).

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A computerized method for enhancing semantic capabilities, the method comprising:
(a) receiving, by a processor, a start word and a target word;
(b) displaying a first list of words that are semantically related to the start word;
(c) receiving data indicative of a selected word, selected by a user from the first list of words;
(d) displaying a second list of words that are semantically related to the selected word, if the selected word is not the target word;
(e) receiving data indicative of an additional selected word, selected by the user from the second list of words; and
(f) repeating steps (d) to (e) using the additional selected word as the selected word, until a first criterion is met.

2. The method of claim 1 wherein the first criterion is met by the additional selected word being the target word.

3. The method of claim 1 wherein the start word and the end word are connected by at least one path.

4. The method of claim 1 wherein the start word and the target word are associated with a challenge.

5. The method of claim 4 further comprising calculating a grade for the given challenge.

6. The method of claim 5 wherein the challenge is associated with a difficulty level.

7. A system for enhancing semantic capabilities, the system comprising a processor configured to:
(a) receive a start word and a target word;
(b) display a first list of words that are semantically related to the start word;
(c) receive data indicative of a selected word, selected by a user from the first list of words;
(d) display a second list of words that are semantically related to the selected word, if the selected word is not the target word;
(e) receive data indicative of an additional selected word, selected by the user from the second list of words; and
(f) repeat steps (d) to (e) using the additional selected word as the selected word, until a first criterion is met.

8. The system of claim 7 wherein the first criterion is met by the additional selected word being the target word.

9. The system of claim 7 wherein the start word and the end word are connected by at least one path.

10. The system of claim 7 wherein the start word and the target word are associated with a challenge.

11. The system of claim 10 wherein said processor is further configured to calculate a grade for the given challenge.

12. The system of claim 11 wherein the challenge is associated with a difficulty level.

13. A program storage device readable by machine, tangibly embodying a program of instructions executable by the machine to perform a method of claim 1.
